(19) United States
(12) Patent Application Publication
(10) Pub. No.: US 2025/0053854 A1
(43) Pub. Date: Feb. 13, 2025

(54) AUTOMATIC EFFECT GENERATION

(71) Applicant: Lemon Inc., Grand Cayman (KY)

(72) Inventors: Jie Meng, Los Angeles, CA (US); Jagminder Shergill, Los Angeles, CA (US); Shih-Kuang Chu, Los Angeles, CA (US); Diego Escala, Los Angeles, CA (US); Jiayue Zhu, Los Angeles, CA (US)

(21) Appl. No.: 18/233,262

(22) Filed: Aug. 11, 2023

(51) Int. Cl. G06N 20/00; G06F 9/445

(52) U.S. Cl. CPC G06N 20/00; G06F 9/44578

(57) ABSTRACT

The present disclosure describes techniques for automatically generating effects. A plurality of effect ideas may be generated by at least one trained machine learning model in response to receiving text input by a user. An effect idea may be decomposed into a plurality of components in response to selecting the effect idea. The effect idea may be among the plurality of effect ideas. Executable code may be generated based on decomposing the effect idea. The code may be executed by a predetermined effect creation tool to generate an effect. The generated effect may be output.

### BACKGROUND

Communication is increasingly being conducted using Internet-based tools. The Internet-based tools may be any software or platform. Users may create content and design features via such Internet-based tools. Improved techniques for content creation and feature design via such tools are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for automatic effect generation in accordance with the present disclosure.

FIG. 2 shows an example user interface for automatic effect generation in accordance with the present disclosure.

FIG. 3 shows an example user interface for automatic effect generation in accordance with the present disclosure.

FIG. 4 shows an example user interface for automatic effect generation in accordance with the present disclosure.

FIG. 5 shows an example flow diagram depicting script generation in accordance with the present disclosure.

FIG. 6 shows an example process for automatic effect generation.

FIG. 7 shows another example process for automatic effect generation.

FIG. 8 shows another example process for automatic effect generation.

FIG. 9 shows another example process for automatic effect generation.

FIG. 10 shows another example process for automatic effect generation.

FIG. 11 shows another example process for automatic effect generation.

FIG. 12 shows an example computing device which may be used to perform any of the techniques disclosed herein.

### DETAILED DESCRIPTION OF ILLUSTRATIVE EMBODIMENTS

Communication can be conducted using Internet-based tools that allow users to create content (e.g., image and/or video content) and distribute the content to other users for consumption. Such Internet-based tools may provide users with various effects (e.g., filters) to use when creating content. Effects are features that may be used to enhance or modify content. As such, effects may provide content creators with more power to express their creativity. Effects may include, for example, beauty filters and/or augmented reality (AR) filters. Beauty filters may be configured to enhance facial features, smooth skin, add makeup, change facial characteristics, and/or the like. AR filters may be configured to overlay digital elements onto the real-world environment depicted in the content. AR filters may be used to add objects, masks, backgrounds, interactive elements, and/or the like to content.

Effects may be created using effect creation tools (e.g., EffectHouse, Lens Studio, etc.). When using the effect creation tools to create effects, a user (e.g., effect creator) may need to perform complex user interface (UI) operations. However, an effect creator may need a substantial amount of domain knowledge or experience before he or she is able to perform such complex UI operations. As such, the complexity of such UI operations may create a high barrier to entry for effect creation. Further, effect creation may be overly time consuming. For most beginner to intermediate level effect creators, building effects to realize their ideas may consume a prohibitive amount of time. Accordingly, improved techniques for effect generation are desirable.

Described herein are improved techniques for effect generation. The techniques described herein utilize artificial intelligence (AI) technologies to automatically generate effects given a text input received from a user (e.g., effect creator). As such, the techniques described herein may be utilized by effect creators with little to no domain knowledge or experience and the techniques described herein may be more efficient (e.g., less time consuming) than existing effect generation techniques.

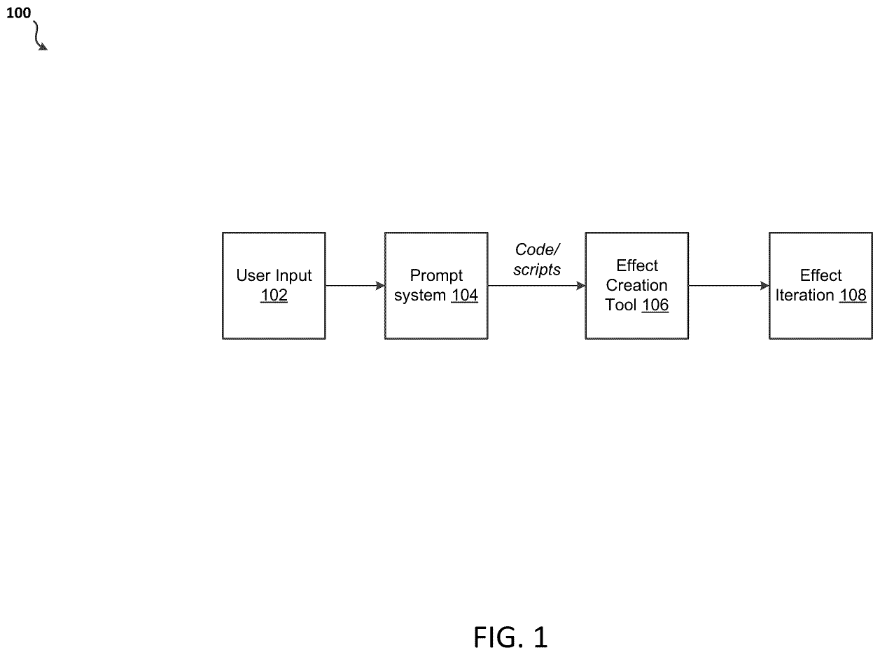

FIG. 1 illustrates an example system 100 for automatically generating effects, such as effects that may be used to enhance or modify content (e.g., image content, video content, etc.). The system 100 may comprise a prompt system 104, an effect creation tool 106, and an effect iteration 108. The prompt system 104, the effect creation tool 106, and the effect iteration 108 may communicate with each other via one or more networks.

The prompt system 104 may receive user input 102. The user input 102 may comprise any text input. The user input 102 may comprise voice (e.g., audio) input. If the user input 102 comprises voice input, the voice input may be converted to text input using any suitable speech-to-text translation technique. The user input 102 may be received via a user interface. The user input 102 may be received via a user interface. The user input 102 received via the user interface may be sent (e.g., forwarded) to the prompt system 104.

For example, a user may enter one or more letters, symbols, words, phrases, or sentences in one or more text boxes on a user interface. For example, a user may enter the word “birthday” into the text box. The user may click one or more “run” buttons in response to populating the text box. The letters, symbols, words, phrases, or sentences entered by the user may be indicative of an effect that the user wants to generate. For example, if the user enters “birthday” into the text box, this may indicate that the user wants to generate a birthday themed effect. Based on (e.g., in response to) the user selecting the run button(s) on the user interface, the letters, symbols, words, phrases, or sentences entered by the user may be sent (e.g., forwarded) to the prompt system 104.

The prompt system 104 may receive the user input (e.g., the letters, symbols, words, phrases, or sentences). The prompt system 104 may generate executable code and/or scripts based on (e.g., using) the user input 102. The prompt system 104 may comprise one or more machine learning models, such as large language models. Each of the machine learning models may comprise an artificial intelligence (AI) algorithm. The AI algorithm may utilize deep learning techniques and massively large data sets to process and understand language (e.g., text). Each of the machine learning models may be trained with immense amounts of data to learn language patterns so that the machine learning models can perform tasks. For example, each of the machine learning models of the prompt system 104 may be trained to process and understand language (e.g., text, the user input 102) to generate executable code and/or scripts. The machine learning models may be configured to receive, as input, the user input 102. The machine learning models may be configured to generate, based on the user input 102, the executable code and/or scripts. The machine learning models may output the generated executable code and/or scripts.

In embodiments, to generate the executable code and/or scripts, the machine learning models may generate one or more effect ideas corresponding to the user input 102. For example, if the user input 102 comprises the word “birthday,” the machine learning models may generate a “cake smash” effect idea. The “cake smash” effect idea may comprise an AR filter that lets a user virtually “smash” a cake on their face (or on another region of an image or video content item). The “cake smash” effect idea may comprise an AR filter that displays confetti and balloons bursting over at least a region of an image or video content item. In addition to the “cake smash” effect idea, the machine learning models may generate other (e.g., additional, or alternative) effect ideas corresponding to the user input of “birthday.” If the machine learning models generate more than one effect idea corresponding to the user input 102, the user may select an effect idea that he or she likes best. For example, a list of effect ideas corresponding to the user input may be output (e.g., displayed) on a user interface. The user may select a desired effect idea from a list of effect ideas corresponding to the user input 102.

In embodiments, to generate the executable code and/or scripts, the machine learning models may decompose one of the effect ideas into effect descriptions (e.g., components). The effect idea decomposed by the machine learning models may comprise the effect idea selected by the user. Alternatively, the effect idea decomposed by the machine learning models may comprise an effect idea selected by the machine learning models. For example, the machine learning models may automatically select an effect idea, such as the first effect idea, from the plurality of effect ideas. The effect descriptions (e.g., components) may comprise one or more of a scene description, an asset description, or an interaction description.

For example, the “cake smash” effect idea may be decomposed into effect descriptions (e.g., components). The effect descriptions associated with the cake mash” effect idea may comprise a scene description. The scene description may comprise details indicating that the scene associated with the effect idea includes three-dimensional (3D) objects, such as a cake, confetti and balloons bursting all around. The scene description may comprise details indicating that facial tracking is used to track a user's face when smashing the virtual cake.

The effect descriptions associated with the “cake smash” effect idea may comprise an asset description. The asset description may comprise images of a cake, confetti, and balloons. The asset description may comprise a 3D mesh of the cake and confetti. The asset description may comprise image sequences of balloons bursting. The asset description may comprise materials to make the cake look realistic. The asset description may comprise visual effect (VFX) shaders to add particles to the scene.

The effect descriptions associated with the cake smash” effect idea may comprise an interaction description. The interaction description may comprise details indicating that the user may interact with the effect by virtually smashing the cake on their face. The interaction description may comprise details indicating that the user may interact with the effect by a touch screen interaction. The interaction description may comprise details indicating that the confetti and balloons bursting may be on a timer or triggered by the smashing action.

In embodiments, the prompt system 104 (e.g., the machine learning models configured to process language and perform language-related tasks) may determine components associated with the scene description. The prompt system 104 may determine a detailed list of components associated with the scene description. The detailed list of components may comprise one or more 3D objects, a face tracker, a screen image, etc. For example, the detailed list of components associated with the scene description for the “cake smash” effect idea may comprise 3D objects such as a cake, confetti, balloons, etc. The 3D objects may be placed in the 3D space of the “cake smash” effect. The detailed list of components associated with the scene description for the “cake smash” effect idea may comprise a face tracker configured to track the user's face when “smashing” the virtual cake. The detailed list of components associated with the scene description for the “cake smash” effect idea may comprise a screen image. The screen image may be an image depicting balloons bursting. The screen image may be placed on the screen during use of the effect.

In embodiments, the prompt system 104 may determine assets associated with the asset description. The prompt system 104 may determine a detailed list of assets associated with the asset description. The detailed list of assets may comprise one or more images, animation keyframes, materials, textures, 3D meshes, diffuse, normal, and/or specular maps, a particle system, image sequences, shaders, and/or the like. One or more machine learning models, such as artificial intelligence generated content models, may be used to generate the assets in the list of assets. The artificial intelligence generated content model(s) may comprise machine learning model(s) that are trained to assist or replace manual content generation by generating content based on user-inputted keywords or requirements.

For example, the list of assets associated with the asset description for the “cake smash” effect idea may comprise the 3D mesh of a cake and confetti. The list of assets associated with the asset description for the “cake smash” effect idea may comprise diffuse, normal, and/or specular maps configured to make the cake look realistic. The list of assets associated with the asset description for the “cake smash” effect idea may comprise a particle system to make the scattering effect of the confetti look realistic. The list of assets associated with the asset description for the “cake smash” effect idea may comprise one or more textures (e.g., makeup texture, smearing texture, dripping texture, etc.) for the face tracker component to realistically simulate the effect of cake on the user's face. The list of assets associated with the asset description for the “cake smash” effect idea may comprise an image sequence of balloons bursting for the screen image component to add a dynamic element to the scene. The list of assets associated with the asset description for the “cake smash” effect idea may comprise VFX shaders for the screen image component to add particles, making the balloons appear livelier and more playful.

In embodiments, the prompt system 104 may determine interactions associated with the interaction description. The prompt system 104 may determine a detailed list of interactions associated with the interaction description. The detailed list of interactions may comprise one or more user interactions (e.g., how users may interact with the components) associated with the interaction description. For example, the detailed list of interactions associated with the interaction description for the “cake smash” effect idea may comprise a tap screen interaction. The user may tap the screen to delay, show, and/or hide object interaction for the 3D cake object.

In embodiments, the prompt system 104 may generate component categories. The component categories may comprise scene components, post-processing components, face effect components, and/or the like. The prompt system 104 may generate the component categories by categorizing the detailed list of components into the various categories. The prompt system 104 may generate component parameters associated with each component of the component categories. The component parameters may comprise component transformations associated with the scene components. The component parameters may comprise post-processing parameter filling associated with the post-processing components. The component parameters may comprise face effect parameter filling associated with the face effect components. For example, the component parameters for the “cake smash” effect idea may comprise the parameters configured to position the cake in the middle of user's face. The prompt system 104 may generate the executable code and/or scripts based on the component parameters associated with each component of the component categories.

In embodiments, the prompt system 104 may send the executable code and/or scripts, to the effect creation tool 106. The effect creation tool 106 may receive the executable code and/or scripts. The effect creation tool 106 may execute the code and/or scripts in an execution environment. To execute the code and/or scripts, the effect creation tool 106 may define (e.g., design, create, generate) a set of application programming interfaces (APIs) within the effect creation tool 106 for generating effects from scripts. The effect creation tool 106 may call the APIs to assemble an effect corresponding to the effect idea. The effect creation tool 106 may build the execution environment for executing the scripts. The effect creation tool 106 may output the generated effect by running the generated script. The generated effect may comprise a filter to use when creating content. The generated effect may be used to enhance or modify content. The generated effect may include, for example, a beauty filter and/or an AR filter.

In embodiments, the effect iteration 108 may enable users to iterate on the generated effect. The effect iteration 108 may enable a user to further input more text to iterate on the generated effect. For example, the user may want to add new elements to the generated effect. As another example, the user may want to remove one or more of the elements in the generated effect. As yet another example, the user may want to replace one or more of the elements in the generated effect. The effect iteration 108 may utilize one or more artificial intelligence generated content models to generate new elements. The effect iteration 108 may add the new elements to the generated effect. The effect iteration 108 may remove one or more of the elements from the generated effect. The effect iteration 108 may replace one or more of the elements in the generated effect with a new element (e.g., an element generated by an artificial intelligence generated content model).

In embodiments, the generated effect may be output. The generated effect may comprise the final effect (e.g., after all iterations, if any, are performed by the effect iteration 108). The output generated effect may be used to modify content, such as image or video content. For example, the output generated effect may be used to modify content before the content is distributed or provided by a content service to subscribers of the content service. The content may comprise short videos. The short videos may have a duration less than or equal to a predetermined time limit, such as one minute, five minutes, or other predetermined minutes. By way of example and without limitation, the short videos may comprise at least one, but no more than four, 15 second segments strung together. The short duration of the videos may provide viewers with quick bursts of entertainment that allow users to watch a large quantity of videos in a short time frame. Such quick bursts of entertainment may be popular on social media platforms.

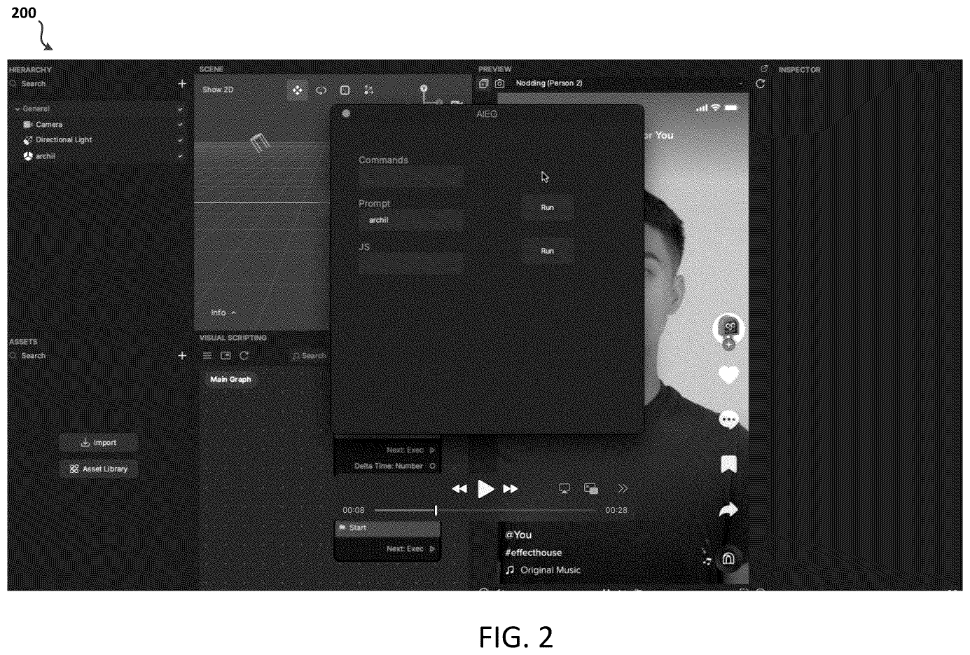

FIG. 2 is an example UI 200. The UI 200 may be configured to receive user text input. The UI 200 may comprise one or more text boxes. The text boxes may comprise a prompt text box. A user may enter user input via the UI 200. The user may enter user input into the prompt text box. The user input may comprise any text input. The user input may comprise one or more letters, symbols, words, phrases, or sentences in the prompt text box. The user may then click one or more “run” buttons. The letters, symbols, words, phrases, or sentences entered by the user may be indicative of an effect that the user wants to generate. As shown in FIG. 2, a user has entered the user input “archi!” into the prompt text box. The user may then select a “run” button. In response to the user selecting the “run” button, the user input may be sent (e.g., forwarded) to a prompt system (e.g., the prompt system 104). The prompt system may utilize the user input to generate executable code and/or scripts based on (e.g., using) the user input. The executable code and/or scripts may be sent to an effect creation tool (e.g., the effect creation tool 106) for generation of an effect.

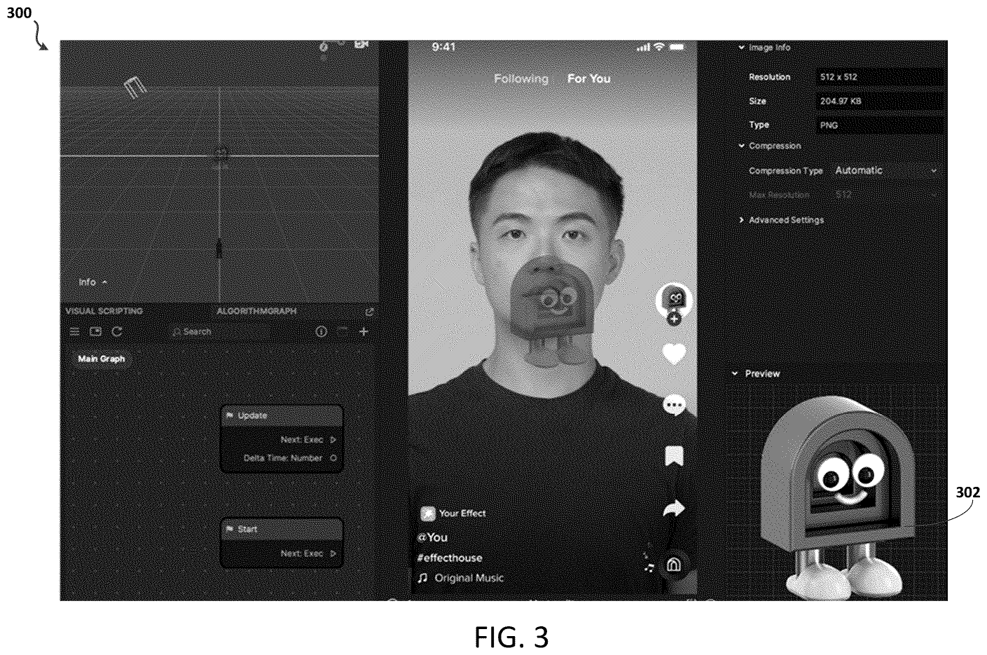

FIG. 3 is an example UI 300. The UI 300 may be configured to display generated effects. The UI 300 may display an effect 302. The effect 302 may have been generated (e.g., by the effect creation tool 106) using the executable code and/or scripts generated by the prompt system based on the user input. For example, the effect 302 have been generated (e.g., by the effect creation tool 106) using the executable code and/or scripts generated by the prompt system 104 based on the user input “archi!” The effect 302 may comprise an augmented reality (AR) filter. The effect 302 may be configured to overlay digital elements (e.g., the arch character/cartoon shown in FIG. 3) onto the real-world environment depicted in image or video content.

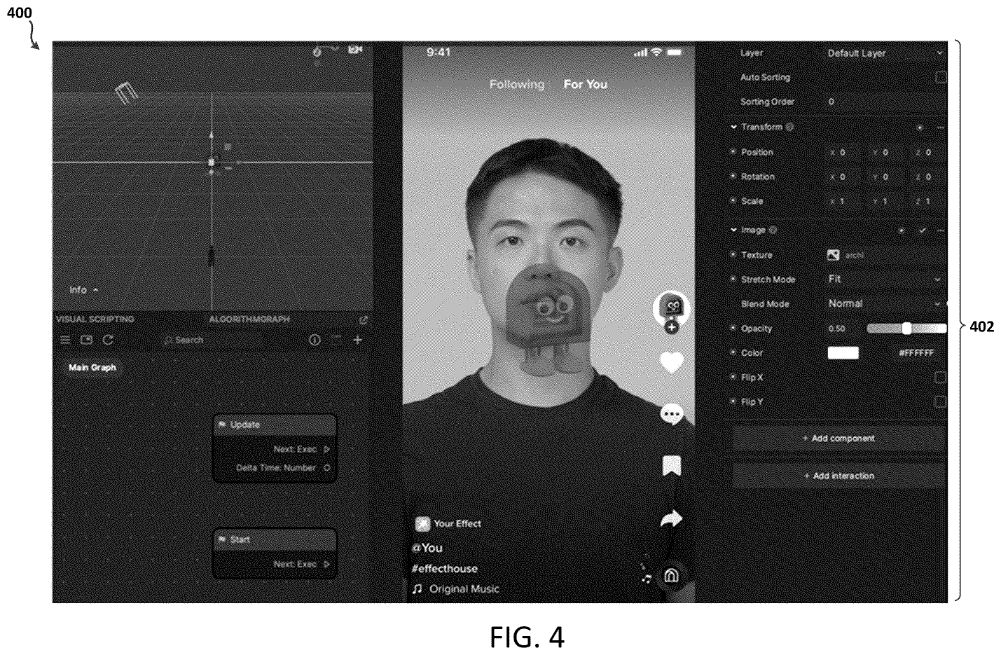

FIG. 4 is an example UI 400. The UI 400 may be used by a user to perform effect iteration. The UI 400 may comprise iteration settings 402. A user may adjust the iteration settings 402 to modify the effect 302. For example, a user may adjust the iteration settings 402 to adjust one or more of a position, rotation, scale, texture, stretch mode, blend mode, color, a horizontal flip, or a vertical flip associated with the effect 302. The generated effect may be output. The generated effect may comprise the final effect (e.g., after all iterations, if any, are performed). The output generated effect may be used to modify content, such as image or video content.

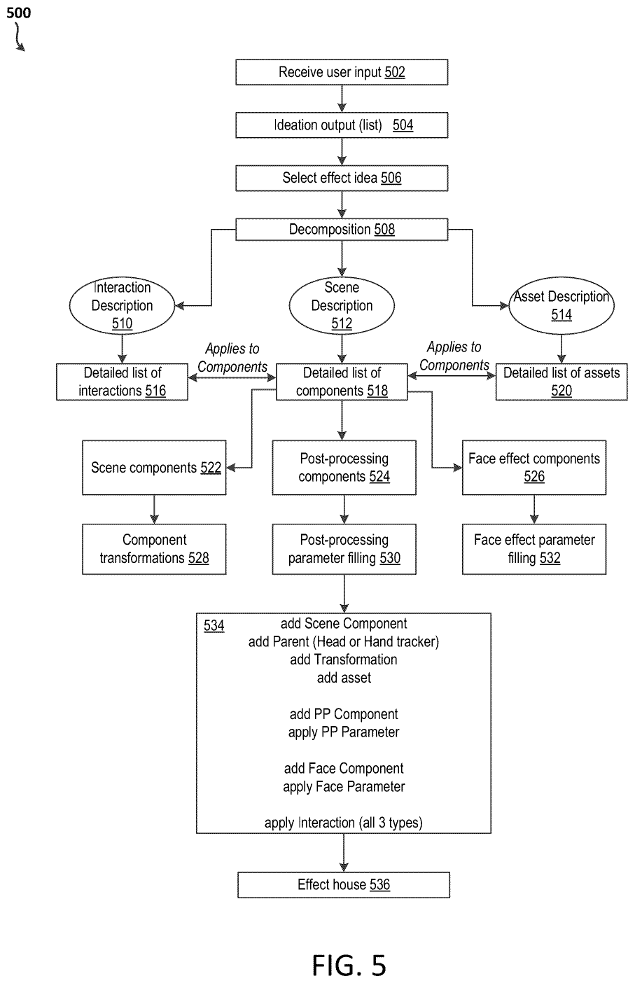

FIG. 5 is an example flow diagram 500. The flow diagram depicts a process for generating executable code and/or scripts. The process may be performed by one or more trained machine learning models to generate executable code and/or scripts based on user input. At 502, user input may be received. The user input may comprise any text input (e.g., one or more letters, symbols, words, phrases, or sentences). The user input may comprise voice (e.g., audio) input. If the user input comprises voice input, the voice input may be converted to text input using any suitable speech-to-text translation technique. The user input may be received via a user interface.

At 504, ideation output may be performed. A list of effect ideas may be output. The effect ideas may correspond to the user input. For example, each of the effect ideas may correspond to an effect that is associated with the user input. At 506, an effect idea may be selected. The effect idea may be selected from the list of effect ideas. The effect idea may be selected by a user. For example, the user may select the effect idea that he or she likes best. Alternatively, the effect idea may be automatically selected (e.g., without user input), such as by a prompt system (e.g., prompt system 104).

At 508, the effect idea may be decomposed. The effect idea may be decomposed into effect descriptions (e.g., components). The effect descriptions (e.g., components) may comprise one or more of a scene description 512, an asset description 514, or an interaction description 510. At 516, a detailed list of interactions may be determined. The detailed list of interactions may comprise one or more user interactions (e.g., how users may interact with the components) associated with the interaction description. At 518, a detailed list of components associated with the scene description may be determined. The detailed list of components associated with the scene description may comprise one or more 3D objects, a face tracker, a screen image, etc. At 520, a detailed list of assets associated with the asset description may be determined. The detailed list of assets may comprise one or more images, animation keyframes, materials, textures, 3D meshes, diffuse, normal, and/or specular maps, a particle system, image sequences, shaders, and/or the like.

The detailed list of components may be categorized into various categories. At 522, a portion of the components in the detailed list of components may be categorized as scene components. At 524, a portion of the components in the detailed list of components may be categorized as post-processing components. At 526, a portion of the components in the detailed list of components may be categorized as face effect components. Component parameters may be generated for each component of the component categories. At 528, component transformations may be generated. The component transformations may be associated with the scene components. At 530, post-processing parameter filling may be generated. The post-processing parameter filling may be associated with the post-processing components. At 532, face effect parameter filling may be generated. The face effect parameter filling may be associated with the face effect components. At 534, executable code and/or scripts may be generated. The executable code and/or scripts may be generated based on component parameters associated with each component of the component categories. At 536, the executable code and/or scripts may be sent to an effect creation tool, such as the Effect House.

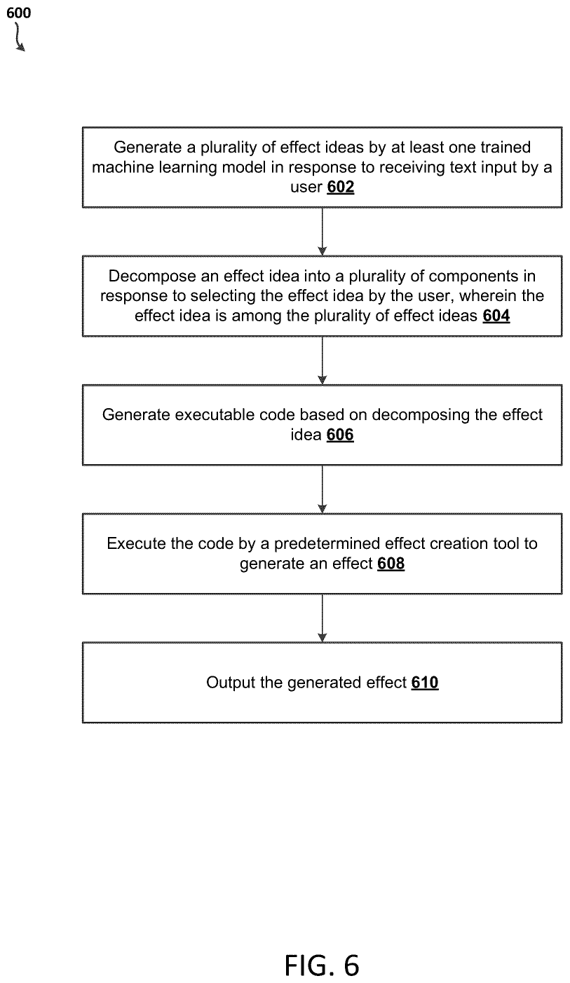

FIG. 6 illustrates an example process 600 performed by one or more components shown in FIG. 1. For example, the process 600 may be performed, at least in part, by the system 100. The process 600 may be performed to automatically generate effects. Although depicted as a sequence of operations in FIG. 6, those of ordinary skill in the art will appreciate that various embodiments may add, remove, reorder, or modify the depicted operations.

At 602, a plurality of effect ideas may be generated. The plurality of effect ideas may be generated by at least one large language model. The plurality of effect ideas may be generated in response to receiving text input by a user. The user input may comprise any text input (e.g., one or more letters, symbols, words, phrases, or sentences). The user input may be received via a user interface. Each of the plurality of effect ideas may correspond to the text input. An effect idea may be selected from the plurality of effect ideas. The effect idea may be selected, for example, by the user. Alternatively, the effect idea may be automatically selected (e.g., without user input).

At 604, the effect idea may be decomposed. The effect idea may be decomposed into a plurality of components. The effect idea may be decomposed in response to selecting the effect idea, such as by the user. The effect idea may be among the plurality of effect ideas. The plurality of components may comprise one or more of 3D objects, a face tracker, a screen image, etc. At 606, executable code may be generated. The executable code may be generated based on decomposing the effect idea.

At 608, the code may be executed. The code may be executed by a predetermined effect creation tool. The code may be executed to generate an effect. The effect creation tool may execute the code and/or scripts in an execution environment. To execute the code and/or scripts, the effect creation tool may define (e.g., design, create, generate) a set of application programming interfaces (APIs) within the effect creation tool for generating effects from scripts. The effect creation tool may call the APIs to assemble the effect corresponding to the effect idea. The effect creation tool may build an execution environment for executing the scripts. The effect creation tool may output the generated effect by running the generated script.

At 610, the generated effect may be output. The output generated effect may be used to modify content, such as image or video content. For example, the output generated effect may be used to modify content before the content is distributed or provided by a content service to subscribers of the content service. The content may comprise short videos. The short videos may have a duration less than or equal to a predetermined time limit, such as one minute, five minutes, or other predetermined minutes. By way of example and without limitation, the short videos may comprise at least one, but no more than four, 15 second segments strung together. The short duration of the videos may provide viewers with quick bursts of entertainment that allow users to watch a large quantity of videos in a short time frame. Such quick bursts of entertainment may be popular on social media platforms.

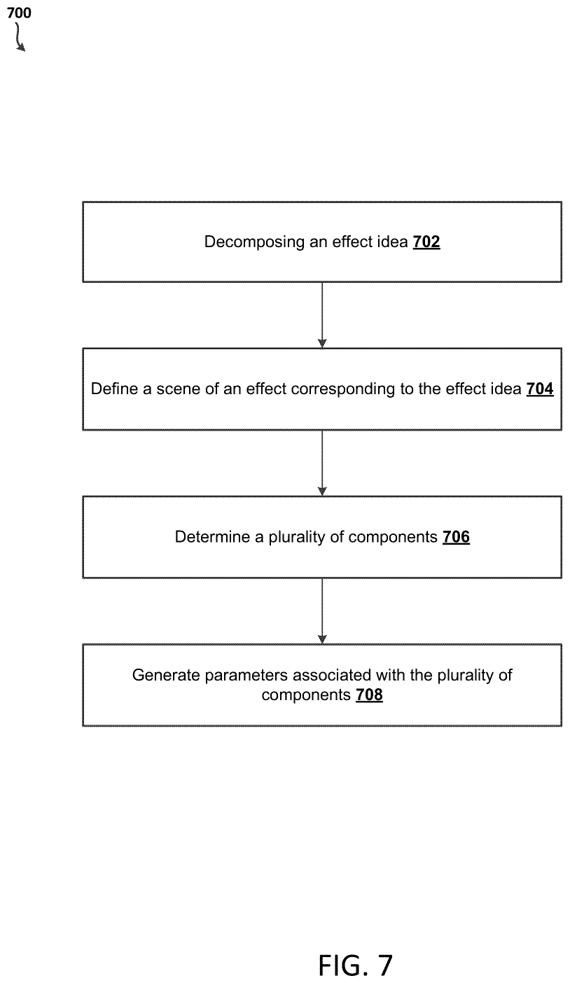

FIG. 7 illustrates an example process 700 performed by one or more components shown in FIG. 1. For example, the process 700 may be performed, at least in part, by the system 100. The process 700 may be performed to automatically generate effects. Although depicted as a sequence of operations in FIG. 7, those of ordinary skill in the art will appreciate that various embodiments may add, remove, reorder, or modify the depicted operations.

At 702, an effect idea may be decomposed. The effect idea may be decomposed into a plurality of components. The effect idea may be decomposed in response to selecting the effect idea, such as by the user. The effect idea may be among the plurality of effect ideas. The plurality of components may comprise one or more of 3D objects, a face tracker, a screen image, etc.

At 704, a scene of an effect may be defined. The effect may correspond to the effect idea. The scene may comprise a plurality of components. The scene may comprise facial tracking. At 706, the plurality of components may be determined. A detailed list of components associated with the scene may be determined. The list of components may comprise one or more 3D objects, a face tracker, a screen image, etc. For example, the list of components associated with the scene description for a “cake smash” effect idea may comprise 3D objects such as a cake, confetti, balloons, etc. The 3D objects may be placed in a 3D space of the “cake smash” effect. The list of components associated with the scene description for the “cake smash” effect idea may comprise a face tracker configured to track a human face when “smashing” the virtual cake. The list of components associated with the scene description for the “cake smash” effect idea may comprise a screen image. The screen image may be an image depicting balloons bursting. The screen image may be placed on the screen during use of the effect.

At 708, parameters may be generated. The parameters may be associated with the plurality of components. The plurality of components may be categorized into different component categories, such as scene components, post-processing components, and face effect components. Component parameters associated with each component of the component categories may be generated. The component parameters may comprise component transformations associated with the scene components. The component parameters may comprise post-processing parameter filling associated with the post-processing components. The component parameters may comprise face effect parameter filling associated with the face effect components. For example, the component parameters for the “cake smash” effect idea may comprise the parameters configured to position the cake in the middle of a face. Executable code and/or scripts may be generated based on the component parameters. An effect creation tool may execute the code and/or scripts in an execution environment to generate the effect. The output generated effect may be used to modify content, such as image or video content.

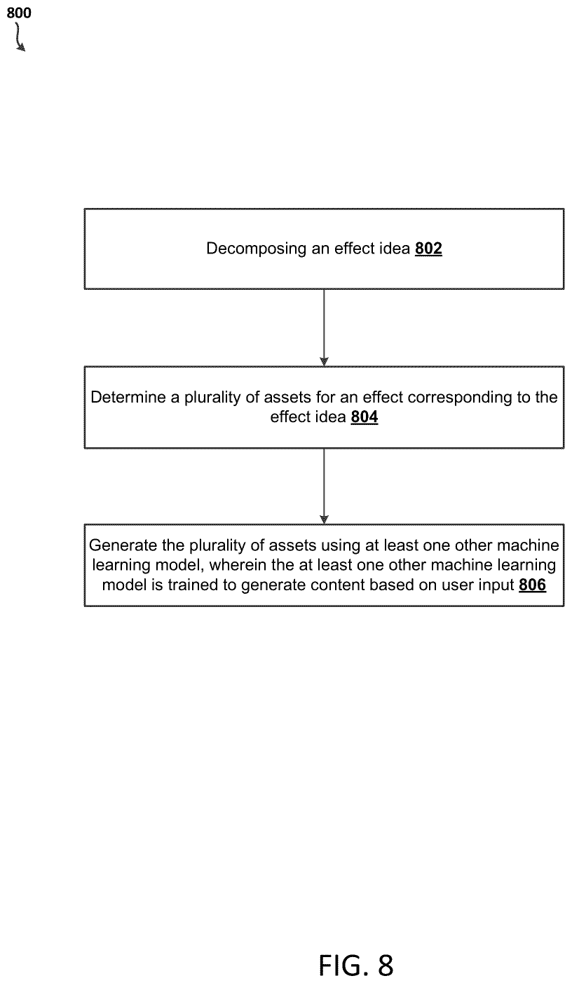

FIG. 8 illustrates an example process 800 performed by one or more components shown in FIG. 1. For example, the process 800 may be performed, at least in part, by the system 100. The process 800 may be performed to automatically generate effects. Although depicted as a sequence of operations in FIG. 8, those of ordinary skill in the art will appreciate that various embodiments may add, remove, reorder, or modify the depicted operations.

At 802, an effect idea may be decomposed. The effect idea may be decomposed into a plurality of components. The effect idea may be decomposed in response to selecting the effect idea by the user. The effect idea may be among the plurality of effect ideas. The plurality of components may comprise one or more of 3D objects, a face tracker, a screen image, etc. At 804, a plurality of assets may be determined. The plurality of assets may be for an effect. The effect may correspond to the effect idea. A detailed list of assets associated with the effect may be determined. The list of assets may comprise one or more images, animation keyframes, materials, textures, 3D meshes, diffuse, normal, and/or specular maps, a particle system, image sequences, shaders, and/or the like. At 806, the plurality of assets may be generated. One or more artificial intelligence generated content models may be used to generate the assets.

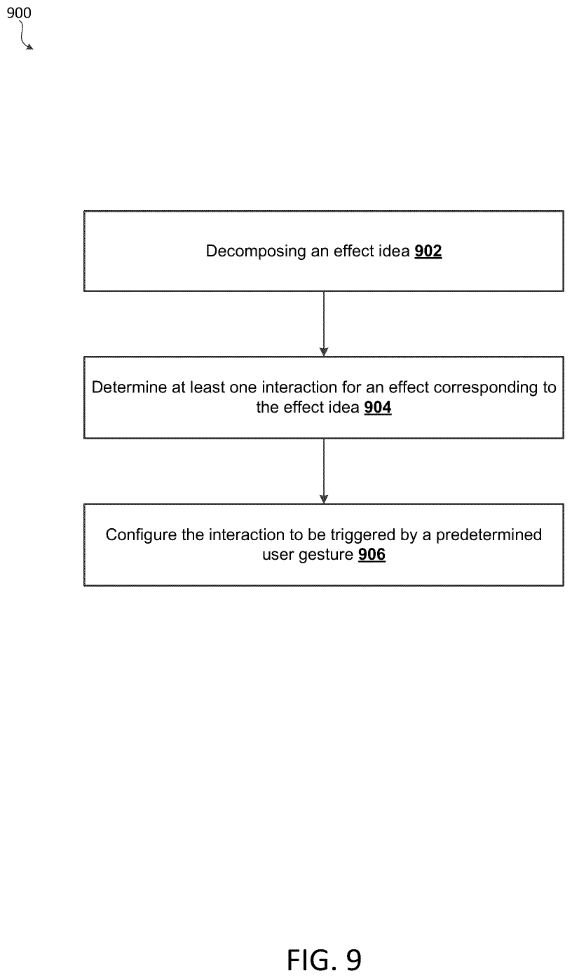

FIG. 9 illustrates an example process 900 performed by one or more components shown in FIG. 1. For example, the process 900 may be performed, at least in part, by the system 100. The process 900 may be performed to automatically generate effects. Although depicted as a sequence of operations in FIG. 9, those of ordinary skill in the art will appreciate that various embodiments may add, remove, reorder, or modify the depicted operations.

At 902, an effect idea may be decomposed. The effect idea may be decomposed into a plurality of components. The effect idea may be decomposed in response to selecting the effect idea by the user. The effect idea may be among the plurality of effect ideas. The plurality of components may comprise one or more of 3D objects, a face tracker, a screen image, etc. At 606, executable code may be generated.

At 904, at least one interaction may be determined. The at least one interaction may be determined for an effect. The effect may correspond to the effect idea. The at least one interaction may comprise one or more user interactions (e.g., how users may interact with the plurality of components). For example, the one or more interactions may comprise showing or hiding object(s) in response to receiving user input, e.g., a tap screen gesture, a finger slide gesture, a voice instruction, a bodily movement, etc. For example, the user may perform one or more gestures to delay, show, and/or hide one or more of the plurality of components. At 906, the interaction may be configured. The interaction may be configured to be triggered by a predetermined user gesture. For example, the interaction may be configured to be triggered by tap screen gesture, a finger slide gesture, a voice instruction, a bodily movement, etc.

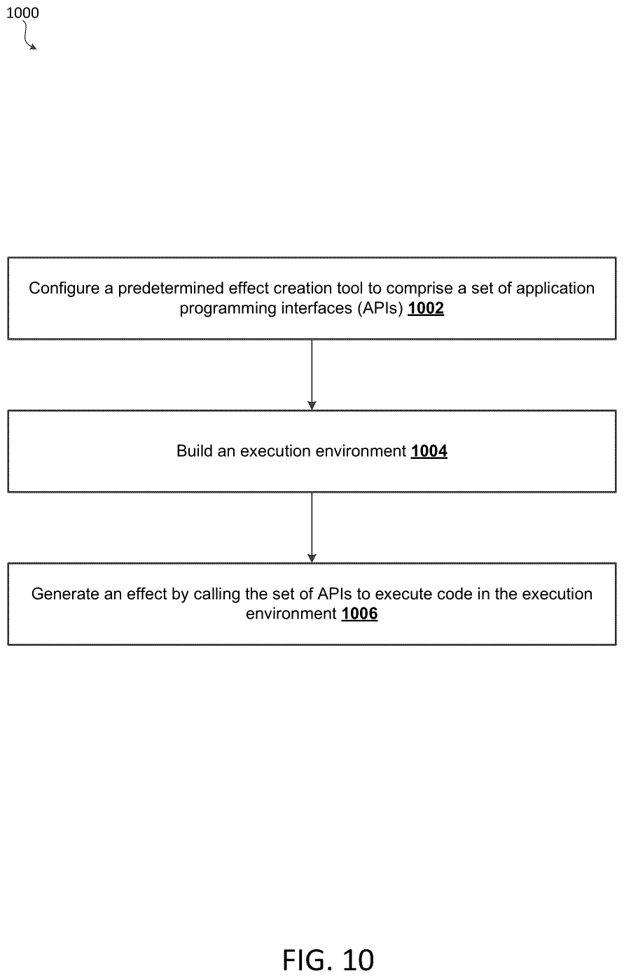

FIG. 10 illustrates an example process 1000 performed by one or more components shown in FIG. 1. For example, the process 1000 may be performed, at least in part, by the system 100. The process 1000 may be performed to automatically generate effects. Although depicted as a sequence of operations in FIG. 10, those of ordinary skill in the art will appreciate that various embodiments may add, remove, reorder, or modify the depicted operations.

At 1002, a predetermined effect creation tool may be configured. The predetermined effect creation tool may be configured to comprise a set of application programming interfaces (APIs). The set of application programming interfaces (APIs) may be created within the effect creation tool 106 for generating effects from scripts. The effect creation tool may call the APIs to assemble an effect corresponding to an effect idea. At 1004, an execution environment may be built. The predetermined effect creation tool may receive executable code and/or scripts associated with an effect. The execution environment is built for executing the code/scripts.

At 1006, an effect may be generated. The effect may be generated by calling the set of APIs to execute the code and/or scripts in the execution environment. The predetermined effect creation tool may output the generated effect by running the code/scripts generated by a prompt system (e.g., the prompt system 104). The generated effect may be used to modify content, such as image or video content. For example, the generated effect may be used to modify content before it is distributed or provided by a content service to subscribers of the content service. The content may comprise short videos. The short videos may have a duration less than or equal to a predetermined time limit, such as one minute, five minutes, or other predetermined minutes. By way of example and without limitation, the short videos may comprise at least one, but no more than four, 15 second segments strung together. The short duration of the videos may provide viewers with quick bursts of entertainment that allow users to watch a large quantity of videos in a short time frame. Such quick bursts of entertainment may be popular on social media platforms.

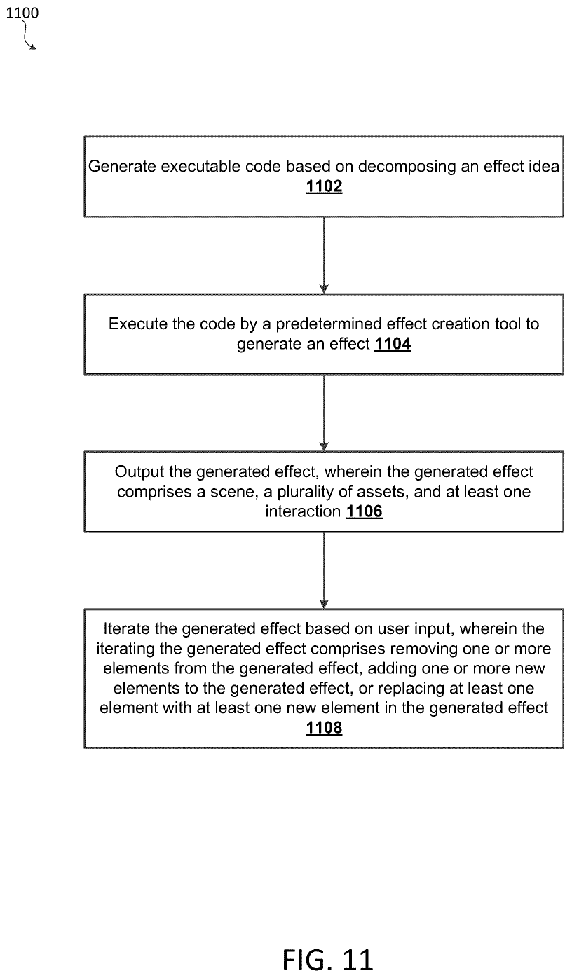

FIG. 11 illustrates an example process 1100 performed by one or more components shown in FIG. 1. For example, the process 1100 may be performed, at least in part, by the system 100. The process 1100 may be performed to automatically generate effects. Although depicted as a sequence of operations in FIG. 11, those of ordinary skill in the art will appreciate that various embodiments may add, remove, reorder, or modify the depicted operations.

At 1102, executable code/scripts may be generated. The executable code/scripts may be generated based on decomposing an effect idea by a prompt system (e.g., the prompt system 106). The effect idea may be decomposed into a plurality of components. The effect idea may be decomposed in response to selecting the effect idea by the user. The effect idea may be among a plurality of effect ideas generated by the prompt system. The plurality of components may comprise one or more of 3D objects, a face tracker, a screen image, etc.

At 1104, the code/scripts may be executed. The code/scripts may be executed by a predetermined effect creation tool. The code/scripts may be executed to generate an effect. The effect creation tool may execute the code and/or scripts in an execution environment. To execute the code and/or scripts, the effect creation tool may define (e.g., design, create, generate) a set of application programming interfaces (APIs) within the effect creation tool for generating effects from scripts. The effect creation tool may call the APIs to assemble the effect corresponding to the effect idea. The effect creation tool may build the execution environment for executing the code/scripts. The effect creation tool may output the generated effect by running the generated code/script. At 1106, the generated effect may be output. The generated effect may comprise a scene. The generated effect may comprise a plurality of assets. The generated effect may comprise and at least one interaction.

At 1108, the generated effect may be iterated. The generated effect may be iterated based on user input. Iterating the generated effect may comprise removing one or more elements from the generated effect. Iterating the generated effect may comprise adding one or more new elements to the generated effect. Iterating the generated effect may comprise replacing at least one element with at least one new element in the generated effect. Iterating the generated effect may comprise utilizing one or more artificial intelligence generated content models to generate new elements and add the new elements to the generated effect, remove one or more of the elements from the generated effect, and/or replace one or more of the elements in the generated effect. A final effect may be output. The final effect is an effect after all iterations, if any, are performed. The output final effect may be used to modify content, such as image or video content.

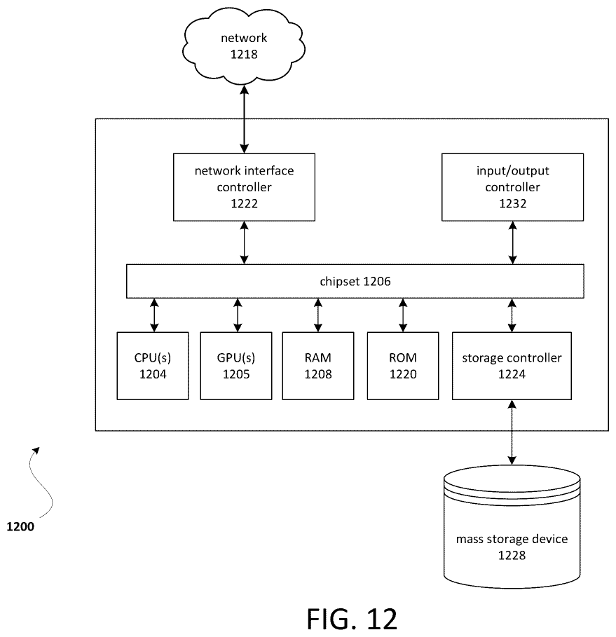

FIG. 12 illustrates a computing device that may be used in various aspects, such as the services, networks, modules, and/or devices depicted in FIG. 1. With regard to the example architecture of FIG. 1, any of the components of the system 100 may each be implemented by one or more instance of a computing device 1200 of FIG. 12. The computer architecture shown in FIG. 12 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1200 may include a baseboard, or “motherboard,” which is a printed circuit board to which a multitude of components or devices may be connected by way of a system bus or other electrical communication paths. One or more central processing units (CPUs) 1204 may operate in conjunction with a chipset 1206. The CPU(s) 1204 may be standard programmable processors that perform arithmetic and logical operations necessary for the operation of the computing device 1200.

The CPU(s) 1204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1204 may be augmented with or replaced by other processing units, such as GPU(s) 1205. The GPU(s) 1205 may comprise processing units specialized for but not necessarily limited to highly parallel computations, such as graphics and other visualization-related processing.

A chipset 1206 may provide an interface between the CPU(s) 1204 and the remainder of the components and devices on the baseboard. The chipset 1206 may provide an interface to a random-access memory (RAM) 1208 used as the main memory in the computing device 1200. The chipset 1206 may further provide an interface to a computer-readable storage medium, such as a read-only memory (ROM) 1220 or non-volatile RAM (NVRAM) (not shown), for storing basic routines that may help to start up the computing device 1200 and to transfer information between the various components and devices. ROM 1220 or NVRAM may also store other software components necessary for the operation of the computing device 1200 in accordance with the aspects described herein.

The computing device 1200 may operate in a networked environment using logical connections to remote computing nodes and computer systems through local area network (LAN). The chipset 1206 may include functionality for providing network connectivity through a network interface controller (NIC) 1222, such as a gigabit Ethernet adapter. A NIC 1222 may be capable of connecting the computing device 1200 to other computing nodes over a network 1216. It should be appreciated that multiple NICs 1222 may be present in the computing device 1200, connecting the computing device to other types of networks and remote computer systems.

The computing device 1200 may be connected to a mass storage device 1228 that provides non-volatile storage for the computer. The mass storage device 1228 may store system programs, application programs, other program modules, and data, which have been described in greater detail herein. The mass storage device 1228 may be connected to the computing device 1200 through a storage controller 1224 connected to the chipset 1206. The mass storage device 1228 may consist of one or more physical storage units. The mass storage device 1228 may comprise a management component 1212. A storage controller 1224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1200 may store data on the mass storage device 1228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1228 is characterized as primary or secondary storage and the like.

For example, the computing device 1200 may store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 may further read information from the mass storage device 1228 by detecting the physical states or characteristics of one or more particular locations within the physical storage units.

In addition to the mass storage device 1228 described above, the computing device 1200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1228 depicted in FIG. 12, may store an operating system utilized to control the operation of the computing device 1200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1228 may store other system or application programs and data utilized by the computing device 1200.

The mass storage device 1228 or other computer-readable storage media may also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described above. The computing device 1200 may have access to computer-readable storage media storing computer-executable instructions, which, when executed by the computing device 1200, may perform the methods described herein.

A computing device, such as the computing device 1200 depicted in FIG. 12, may also include an input/output controller 1232 for receiving and processing input from a number of input devices, such as a keyboard, a mouse, a touchpad, a touch screen, an electronic stylus, or other type of input device. Similarly, an input/output controller 1232 may provide output to a display, such as a computer monitor, a flat-panel display, a digital projector, a printer, a plotter, or other type of output device. It will be appreciated that the computing device 1200 may not include all of the components shown in FIG. 12, may include other components that are not explicitly shown in FIG. 12, or may utilize an architecture completely different than that shown in FIG. 12.

As described herein, a computing device may be a physical computing device, such as the computing device 1200 of FIG. 12. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of automatically generating effects, comprising:
generating a plurality of effect ideas by at least one trained machine learning model in response to receiving text input;
decomposing an effect idea into a plurality of components in response to selecting the effect idea, wherein the effect idea is among the plurality of effect ideas;
generating executable code based on decomposing the effect idea;
executing the code by a predetermined effect creation tool to generate an effect; and
output the generated effect.

2. The method of claim 1, wherein the decomposing an effect idea further comprises:
defining a scene of the effect;
determining the plurality of components; and
generating parameters associated with the plurality of components.

3. The method of claim 1, wherein the decomposing an effect idea further comprises determining a plurality of assets for the effect.

4. The method of claim 3, further comprising:
generating the plurality of assets using at least one other machine learning model, wherein the at least one other machine learning model is trained to generate content based on user input.

5. The method of claim 1, wherein the decomposing an effect idea further comprises determining at least one interaction for the effect.

6. The method of claim 5, further comprising:
configuring the at least one interaction to be triggered by a predetermined user gesture.

7. The method of claim 1, wherein the generated effect comprises a scene, a plurality of assets, and at least one interaction.

8. The method of claim 1, wherein the executing the code by a predetermined effect creation tool to generate the effect further comprises:
configuring the predetermined effect creation tool to comprise a set of application programming interfaces (APIs);
building an execution environment; and
generating the effect by calling the set of APIs to execute the code in the execution environment.

9. The method of claim 1, further comprising:
iterating the generated effect based on user input, wherein the iterating the generated effect comprises removing one or more elements from the generated effect, adding one or more new elements to the generated effect, or replacing at least one element with at least one new element in the generated effect.

10. A system, comprising:
at least one processor; and
at least one memory comprising computer-readable instructions that upon execution by the at least one processor cause the system to perform operations comprising:
generating a plurality of effect ideas by at least one trained machine learning model in response to receiving text input;
decomposing an effect idea into a plurality of components in response to selecting the effect idea, wherein the effect idea is among the plurality of effect ideas;
generating executable code based on decomposing the effect idea; and
executing the code by a predetermined effect creation tool to generate an effect; and
output the generated effect.

11. The system of claim 10, wherein the decomposing an effect idea further comprises:
defining a scene of the effect;
determining the plurality of components; and
generating parameters associated with the plurality of components.

12. The system of claim 10, wherein the decomposing an effect idea further comprises determining a plurality of assets for the effect, and wherein the operations further comprise:
generating the plurality of assets using at least one other machine learning model, wherein the at least one other machine learning model is trained to generate content based on user input.

13. The system of claim 10, wherein the decomposing an effect idea further comprises determining at least one interaction for the effect, and wherein the operations further comprise:
configuring the at least one interaction to be triggered by a predetermined user gesture.

14. The system of claim 10, wherein the generated effect comprises a scene, a plurality of assets, and at least one interaction.

15. The system of claim 10, wherein the executing the code by a predetermined effect creation tool to generate the effect further comprises:
configuring the predetermined effect creation tool to comprise a set of application programming interfaces (APIs);
building an execution environment; and
generating the effect by calling the set of APIs to execute the code in the execution environment.

16. The system of claim 10, further comprising:
iterating the generated effect based on user input, wherein the iterating the generated effect comprises removing one or more elements from the generated effect, adding one or more new elements to the generated effect, or replacing at least one element with at least one new element in the generated effect.

17. A non-transitory computer-readable storage medium, storing computer-readable instructions that upon execution by a processor cause the processor to implement operations, the operation comprising:
generating a plurality of effect ideas by at least one trained machine learning model in response to receiving text input;
decomposing an effect idea into a plurality of components in response to selecting the effect idea, wherein the effect idea is among the plurality of effect ideas;
generating executable code based on decomposing the effect idea; and
executing the code by a predetermined effect creation tool to generate an effect; and
output the generated effect.

18. The non-transitory computer-readable storage medium of claim 17, wherein the decomposing an effect idea further comprises:
defining a scene of the effect;
determining the plurality of components; and
generating parameters associated with the plurality of components.

19. The non-transitory computer-readable storage medium of claim 17, wherein the decomposing an effect idea further comprises determining at least one interaction for the effect, and wherein the operations further comprise:
configuring the at least one interaction to be triggered by a predetermined user gesture.

20. The non-transitory computer-readable storage medium of claim 17, wherein the executing the code by a predetermined effect creation tool to generate the effect further comprises:
configuring the predetermined effect creation tool to comprise a set of application programming interfaces (APIs);
building an execution environment; and
generating the effect by calling the set of APIs to execute the code in the execution environment.
